(19) United States
(12) Patent Application Publication
(10) Pub. No.: US 2004/0042610 A1
(43) Pub. Date: Mar. 4, 2004

(54) Call center system

(76) Inventor: Kazumi Arashi, Kyoto (JP)

Correspondence Address: MERCHANT & GOULD PC, P.O. BOX 2903, MINNEAPOLIS, MN, 55402-0903, US

(21) Appl. No.: 10/465,946

(22) PCT Filed: Dec. 26, 2001
(86) PCT No.: PCT/JP01/11442

(30) Foreign Application Priority Data
Dec. 26, 2000 (JP) 2000-404814

(51) Int. Cl. H04M 3/42; H04M 3/00

(52) U.S. Cl. 379/265.01; 379/212.01

(57) ABSTRACT

A call center system includes a CTI server (1) for transferring a telephone call from a customer telephone (2) to reception terminals (31 to 32) of operators, and a customer information database (4) that stores respective telephone numbers of customers, information regarding responses to inquiries from the customers in the past, etc. In response to reception of a call from a customer telephone (2), the CTI server (1) acquires a telephone number of the customer telephone (2) using an originating number notifying service provided by a telephone network, refers to the customer information database (4) according to the acquired telephone number, and preferentially transfers the call to a reception terminal (31) of an operator that has attended to the customer.

### TECHNICAL FIELD

The present invention relates to a call center system that is capable of quickly transferring a telephone call of inquiry from a customer to an appropriate operator.

### BACKGROUND ART

Recently, a system called “computer telephony integration (CTI)”, in which telephones and computers are integrated, is introduced into a call center.

In response to reception of a telephone call of inquiry from a customer, a CTI server identifies a telephone number of the customer using the originating number notifying function, acquires customer information registered in a database according to the telephone number thus identified, determines an operator who is to temporarily attend to the call by referring to engaged/disengaged states of operators and the like, and transfers the call thereto. When the temporarily attending operator receives the call, the CTI server immediately displays the customer's profile information, inquiry history regarding past inquiries, etc., on a screen in front of the operator. The operator responds to the call viewing the information on the screen.

Upon receiving the inquiry from the customer, the temporarily attending operator is allowed to search a database for past cases with the same contents as that of the inquiry. Therefore, even a less experienced operator can respond to inquiries from customers to some extent. In the case where the content of the inquiry is such that the temporarily attending operator is unable to deal with it, the call is transferred to a secondary responding operator who has more expertise so that the inquiry is answered.

Generally, a temporarily attending operator does not have sufficient expertise in many cases. In the case where an inquiry from a customer relates to breakdown of an equipment or the like, the customer is in a hurry mostly, and the transfer of the call to the secondary responding operator after the customer explained the inquiry to the temporarily attending operator, which causes the customer to repeat the same explanation, sometimes increases the customer's discontent.

### DISCLOSURE OF THE INVENTION

To solve the above-described problems, it is an object of the present invention to provide a call center system that is capable of quickly transferring a telephone call of inquiry from a customer to an appropriate operator.

To achieve the foregoing object, a call center system according to the present invention includes reception terminals of operators, a call transfer device for transferring a received telephone call to one of the reception terminals, and a user information storing device that stores user information regarding each user. In the call center system, the user information stored in the user information storing device includes, regarding each user, a telephone number that the user uses, and usage history information regarding the usage of the call center system by the user. In response to reception of a telephone call from a user, the call transfer device identifies the calling user, refers to the usage history information of the identified user so as to select an operator to attend the identified user, and transfers the user's call to a reception terminal of the selected operator.

With this system, when a user calls the call center, the call transfer device identifies the user, selects an operator who is to respond to the call according to the history information of the usage of the call center by the user, and transfers the call to the selected operator. In other words, since the user is attended to by an operator selected appropriately according to the user's usage history, the call is not transferred successively from one operator to another, which means that the user is not asked to make the same explanation repetitively and accomplishes his/her purpose quickly. Thus, a call center system is provided that is capable of quickly transferring a telephone call of inquiry from a customer to an appropriate operator.

To achieve the foregoing object, a call transfer method for transferring a telephone call from a user to a reception terminal of an operator in a call center, which uses a user information storing device that stores user information regarding each user that includes a telephone number that the user uses and usage history information regarding usage of the call center by the user, includes the following steps: receiving a call from a user; identifying the user; referring to the usage history information of the identified user so as to select an operator who is to attend the identified user; and transferring the user's call to a reception terminal of the selected operator.

By this method, a call center system is provided that is capable of quickly transferring a telephone call of inquiry from a customer to an appropriate operator.

### BRIEF DESCRIPTION OF DRAWINGS

FIG. 1 is a view illustrating a configuration of a call center system.

FIG. 2 is a view illustrating a configuration of a customer information database.

### DESCRIPTION OF THE INVENTION

The following will describe an embodiment of the present invention while referring to the drawings.

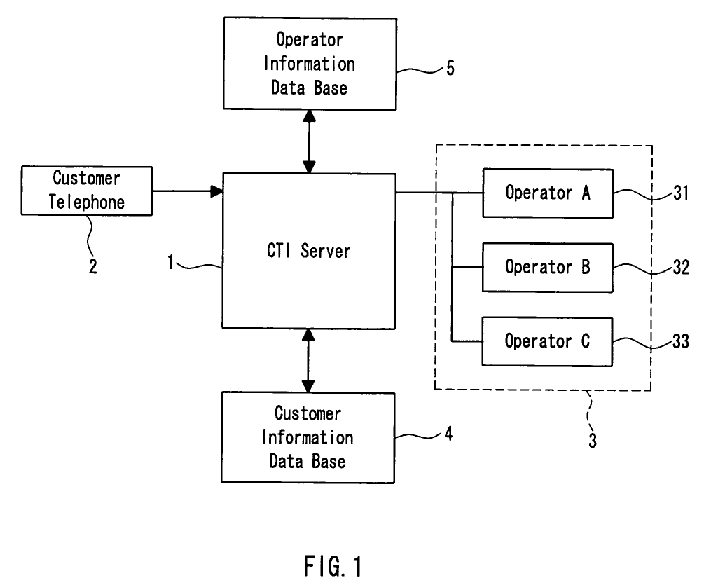

FIG. 1 is a block diagram illustrating a configuration of a call center system according to the present embodiment. In response to reception of a telephone call of inquiry from a customer telephone 2, a computer telephony integration (CTI) server 1 acquires a telephone number of the customer telephone 2 using an originating number notifying service provided by a telephone network. The CTI server 1 searches a customer information database 4 for information about the customer telephone 2 according to the telephone number of the customer telephone 2.

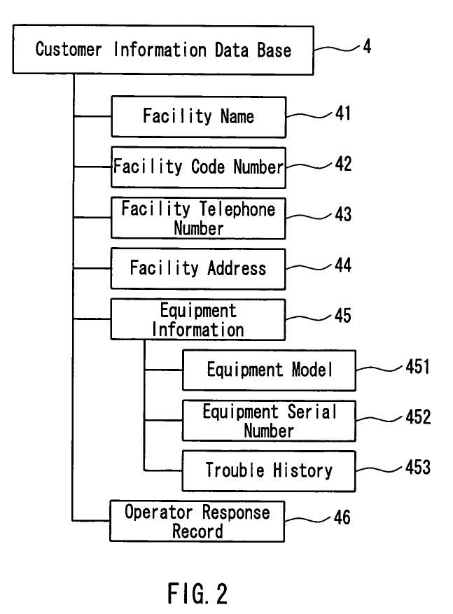

As shown in FIG. 2, the customer information database 4 stores, as information for each customer (customer information), facility name data 41, facility code number data 42, facility telephone number data 43, facility address data 44, equipment information data 45, and operator response record data 46. The operator response record data 46 are produced every time a telephone call of inquiry from a customer is received, and include date and time when the inquiry call was made, a name of an operator who responded to the call, and contents of the inquiry. The equipment information data 45 are composed of equipment model data 451, equipment serial number data 452, and trouble history data 453 that represent states of problems that occurred with equipment of the model concerned (the equipment model indicated by the equipment model data 451) in the past.

The CTI server 1 compares the telephone number of the customer telephone 2 with the facility telephone number data 43 in the customer information database 4, to identify the customer that has made the call. Then, referring to the operator response record data 46 of the identified customer, the CTI server 1 sorts names of operators who have responded to calls of inquiries from the foregoing customer by date of response in reverse chronological order, and selects the operator who has attended the customer latest as a candidate of a destination to which the call is transferred (call transfer destination candidate). Alternatively, the CTI server 1 may select an operator who has attended to the foregoing customer more times (more frequently) than the other operators have done preferentially as the call transfer destination candidate. For instance, in the case where an operator A shown in FIG. 1 is selected as the call transfer destination candidate, the CTI server 1 checks whether or not a reception terminal 31 of the operator A is in an accessible state, and if it is in an accessible state, the CTI server 1 transfers the inquiry call from the customer to the reception terminal 31 of the operator A.

In the case where the reception terminal 31 of the operator A is in an inaccessible state, the CTI server 1 identifies models of the equipment used in the facility of the customer by referring to the equipment model data 451 of the customer information database 4. Further, the CTI server 1 acquires the trouble histories of the equipment used in the facility of the customer by referring to the trouble history data 453, and specifies which model among those of the equipments shown in the equipment model data 451 tends to have troubles. Then, the CTI server 1 refers to an operator information database 5, and selects an operator who has expertise regarding the model specified as tending to have troubles. For instance, in the case where an operator B is selected, the CTI server 1 transfers the inquiry call from the customer telephone 2 to a reception terminal 32 of the operator B.

The operator responds to the inquiry from the customer, and registers the contents of the response in the customer information database 4. The customer information database 4 stores the contents thus registered by the operator as trouble history data 453, and further stores the date and time of the response, the name of the responding operator, and the contents of the inquiry, as operator response record data 46.

In the case where the operator judges that he/she is not sufficiently able to respond to the inquiry of the customer, the operator is allowed to search all the data of the customer information database 4 for response records with respect to past inquiries that had contents identical or similar to the contents of the foregoing inquiry from the customer, and to respond to the inquiry from the customer while having the searched results displayed on a screen of his/her reception terminal.

As described above, the present embodiment eliminates successive transfer of a call from a customer, and does not bother a customer for repetitive explanation. Therefore, the service level to customers is improved.

Furthermore, according to the present embodiment, in determining an operator to whom an inquiry call from a customer is to be transferred, the determination is made with the customer information being taken into consideration preferentially. For instance, the records of past responses by operators to a customer are referred to, and an operator who has experience in responding to inquiries from the customer is selected preferentially, to whom the call is transferred. In the case where the selected operator is not available for receiving the call, the equipment that the customer bought is identified from the equipment information among the items of the customer information, and the call is transferred preferentially to an operator who has expertise in the equipment concerned. By so doing, the customer is attended to by an operator who has attended to the customer or an operator who has expertise in the equipment concerned, without passing through temporary reception. Therefore, an effect of reducing customer's discontent can be achieved.

It should be noted that though the present embodiment is described with reference to a call center system for receiving inquiries regarding equipment, the present invention is not limited to this, but may be applied to call center systems relating to any articles or services.

Further, though in the present embodiment a telephone number of a customer telephone is acquired using the originating number notifying service provided by the telephone network and the customer is identified according to the acquired telephone number, the customer identification method is not limited to this, but any method can be applicable. For instance, a method of asking a customer to input information for identifying the customer (customer ID, customer's name, etc.) by button operations, voice input, etc., through the customer telephone 2 may be used.

### INDUSTRIAL APPLICABILITY

A call of inquiry from a customer is transferred directly to an operator who has attended to the customer in the past or an operator who has expertise in an equipment concerned, without passing through temporary reception. This makes it possible to provide a call center system that is capable of offering high-level service to customers.

1. A call center system comprising:
reception terminals of operators;
a call transfer device for transferring a received telephone call to one of the reception terminals; and
a user information storing device that stores user information regarding each user,
wherein
the user information stored in the user information storing device includes, regarding each user, a telephone number that the user uses, and usage history information regarding the usage of the call center system by the user, and
in response to reception of a telephone call from a user, the call transfer device identifies the calling user, refers to the usage history information of the identified user so as to select an operator to attend the identified user, and transfers the user's call to a reception terminal of the selected operator.

2. The call center system according to claim 1, wherein the user identification is carried out based on a telephone number used by the user that is acquired by using an originating number notifying function provided by a telephone network.

3. The call center system according to claim 1, wherein
the user history information further includes, regarding each user, call history information regarding past calls from the user, and responding operator information used for identifying operators who have attended to the user in the past, and
the call transfer device refers to the call history information and the responding operator information, and preferentially selects an operator who has attended to the identified user latest.

4. The call center system according to claim 1, wherein
the user history information further includes, regarding each user, call history information regarding past calls from the user, and responding operator information used for identifying operators who have attended to the user in the past, and
the call transfer device refers to the call history information and the responding operator information, and preferentially selects an operator who has attended to the identified user most frequently.

5. The call center system according to claim 1, wherein
the user history information further includes, regarding each user, responding operator information used for identifying operators who have attended to the user in the past, and information regarding contents of each call, and
the call transfer device refers to the user history information, and preferentially selects an operator who has an experience of responding to a call with contents identical or similar to the contents of the call received.

6. The call center system according to claim 1, further comprising an operator information storing device that stores operator competence information regarding areas of competence of each operator,
wherein the call transfer device refers to the operator competence information according to contents of the received call from the identified user, and selects an operator who is to attend the user.

7. A call transfer method for transferring a telephone call from a user to a reception terminal of an operator in a call center, using a user information storing device that stores user information regarding each user that includes a telephone number that the user uses and usage history information regarding usage of the call center by the user, the method comprising the steps of:
receiving a call from a user;
identifying the user;
referring to the usage history information of the identified user so as to select an operator who is to attend the identified user; and
transferring the user's call to a reception terminal of the selected operator.

8. The call transfer method according to claim 7, wherein
the user identification is carried out based on a telephone number used by the user that is acquired by using an originating number notifying function provided by a telephone network.
